(19) United States
(12) Patent Application Publication
(10) Pub. No.: US 2007/0008989 A1
(43) Pub. Date: Jan. 11, 2007

(54) Packet processing

(75) Inventor: Abhijeet Joglekar, Hillsboro, OR (US)

Correspondence Address: CAVEN & AGHEVLI;c/o PORTFOLIOIP, P.O. BOX 52050, MINNEAPOLIS, MN, 55402, US

(73) Assignee: Intel Corporation

(21) Appl. No.: 11/171,128

(22) Filed: Jun. 30, 2005

(51) Int. Cl. H04J 3/16

(52) U.S. Cl. 370/469

(57) ABSTRACT

In one embodiment, a method comprises receiving a data packet into a multi-layer communication protocol processor. In at least one protocol layer, the data context data associated with a subsequent protocol layer is prefetched while the data packet is processed in accordance with the current protocol layer. A portion of the processed data packet is passed to the subsequent protocol layer.

### BACKGROUND

Network protocol stacks may be constructed using a layered architecture. Each layer of the protocol stack processes a packet according to one or more discrete protocols then passes the packet to another layer in the stack for subsequent processing. Layered protocol stack architectures permit complex communication process to be broken down into manageable components, and also permit a degree of modularity in system design.

For example, in a network environment a network adapter, such as an Ethernet card or a Fibre Channel card, coupled to a host computer may receive Input/Output (I/O) requests or responses to I/O requests initiated from the host. The host computer operating system may include one or more device drivers to communicate with the network adapter hardware to manage I/O requests transmitted over a network. Data packets received at the network adapter may be stored in an available allocated packet buffer in the host memory. The host computer may also include a transport protocol driver to process the packets received by the network adapter that are stored in the packet buffer, and access I/O commands or data embedded in the packet. The transport protocol driver may include a Transmission Control Protocol (TCP) and Internet Protocol (IP) (TCP/IP) protocol stack to process TCP/IP packets received at the network adapter. Specific computing environments such as, e.g., storage networking environments may implement more complex communication protocols.

When processing a packet in a layered protocol stack, layer-specific protocol state information, also referred to as context, may be accessed from memory at every layer of the protocol stack. Cache misses that occur while retrieving context information may cause significant delays in processing packets, which may adversely affect packet processing throughput.

### BRIEF DESCRIPTION OF THE DRAWINGS

The detailed description is provided with reference to the accompanying figures.

FIG. 1 is a schematic illustration of a computing system in accordance with an embodiment.

FIG. 2 is a schematic illustration of an embodiment of a packet architecture used in example packet processing systems.

FIG. 3 is a schematic illustration of a generic layered packet processing environment in accordance with an embodiment.

FIG. 4 is a flow diagram of an embodiment of a method to process packets in a generic layered packet processing environment.

FIG. 5 is a flow diagram of an embodiment of a method to process packets in a generic layered packet processing environment.

FIG. 6 is a schematic illustration of a specific layered packet processing environment in accordance with an embodiment.

FIGS. 7A-7D are flow diagrams of an embodiment of a method to process packets in the specific layered packet processing environment depicted in FIG. 6.

### DETAILED DESCRIPTION

In the following description, numerous specific details are set forth to facilitate a thorough understanding of various embodiments. However, various embodiments of the invention may be practiced without the specific details. In other instances, well-known methods, procedures, components, and circuits have not been described in detail so as not to obscure the particular embodiments of the invention.

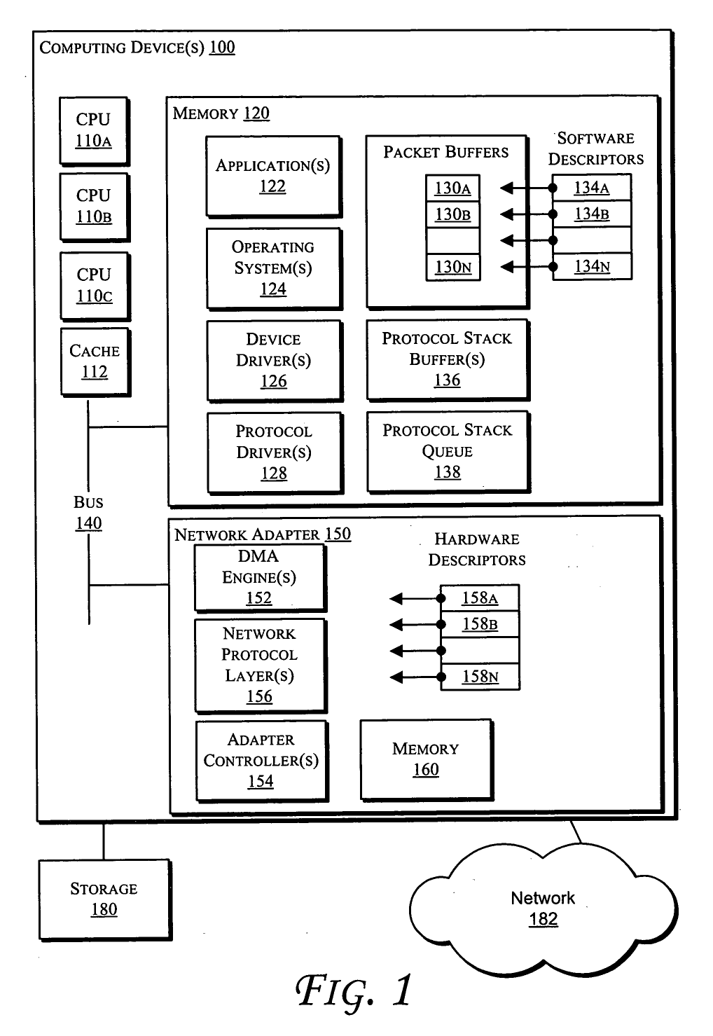

FIG. 1 is a schematic illustration of a computing system in accordance with an embodiment. A computing device 100 includes one or more central processing units (CPUs) 110A, 110B, 110C, a cache 112, a memory module 120 which may be embodied as volatile memory, non-volatile storage 180 which may be embodied as a one or more hard disk drives, a tape drive, or an optical media drive, an operating system 124, and a network adapter 150.

One or more application programs 122 stored in memory 120 may transceive packets with one or more remote computing devices over network 182. The computing device 100 may comprise any suitable computing device such as a mainframe, server, personal computer, workstation, laptop, handheld computer, telephony device, network appliance, virtualization device, storage controller, etc. Any suitable CPU 110A, 110B, 110C and operating system 124 may be used. Programs and data in memory 120 may be swapped into storage 180 as part of memory management operations.

One or more device drivers 126 resides in memory 120 and may include network adapter specific commands to provide a communication interface between the operating system 124 and the network adapter 150. The device driver 126 allocates packet buffers in memory 120 to store packets from the network adapter 150. The network adapter 150 determines available descriptors and writes packets to the buffers assigned to the available descriptors. In described embodiments, the device driver 126 maintains software descriptor elements, where each descriptor element 134A, 134B . . . 134N points to pre-assigned packet buffers 130A, 130B . . . 130N.

Descriptors 134A, 134B . . . 134N point to the buffers, and the hardware and software use the descriptors to manage the buffers. For instance, a descriptor may contain a memory address (e.g., a pointer) of a buffer and is loaded from the system memory 120 into the network adapter 150 hardware. Based on this descriptor, the network adapter 150 hardware may then access the data packet it received from the network into that buffer address, e.g., using Direct Memory Access (DMA). The descriptor thus informs the network adapter hardware where to store the data. The network adapter hardware then writes the descriptor back to system memory setting the status of the descriptor to “done”. The device driver 126 may then determine from that descriptor and indicate the new buffer to the operating system 124.

A packet written to one descriptor 134A, 134B . . . 134N may be stored in a packet buffers 130A, 130B . . . 130N assigned to that descriptor 134A, 134B . . . 134N. A protocol driver 128 implements a protocol, such as a TCP/IP protocol driver, iSCSI protocol driver, Fibre Channel protocol driver, etc., in which the packets are coded and processes the packets to access the data therein. The device driver 126 indicates the buffers to the protocol driver 128 for processing via the protocol stack. The protocol driver 128 may either copy the buffer to its own protocol-owned buffer, such as the protocol stack buffers 136, or use the original buffer indicated by the device driver 126 to process with a protocol stack queue 138.

The network adapter 150 communicates with the device driver 126 via a bus interface 140, which may implement any suitable bus protocol.

The network adapter 150 includes a network protocol layer 156 for implementing the physical communication layer to send and receive network packets to and from remote devices over a network 182. The network 182 may comprise a Local Area Network (LAN), the Internet, a Wide Area Network (WAN), Storage Area Network (SAN), a wireless network, etc. In certain embodiments, the network adapter 150 and network protocol layer 156 may implement the Ethernet protocol, Gigabit (1 or 10) Ethernet, token ring protocol, Fibre Channel protocol, Infiniband, Serial Advanced Technology Attachment (SATA), parallel SCSI, serial attached SCSI cable, etc., or any other switchable network communication protocol.

The network adapter 150 further includes a DMA engine 152, which writes packets to buffers assigned to available descriptors. Network adapter 150 includes a network adapter controller 154 includes hardware logic and or a programmable processor to perform adapter related operations. Network adapter 150 may further include a memory module 160 which may be embodied as any suitable volatile or non-volatile memory and may include cache memory.

In one embodiment, network adapter 150 may maintain hardware descriptor elements 158A, 158B . . . 158N, each corresponding to one software descriptor element 134A, 134B . . . 134N. In this way, the descriptor elements are represented in both the network adapter hardware and the device driver software. Further, the descriptors, represented in both hardware and software, are shared between the device driver 126 and the network adapter 150. The descriptors 134A, 134B . . . 134N are allocated in system memory 120 and the device driver 126 writes a buffer address in the descriptor and submits the descriptor to the network adapter 150. The adapter then loads the descriptor 158A, 158B . . . 158N and uses the buffer address to direct memory access (DMA) packet data into the network adapter 150 hardware to process. When the DMA operations are complete, the hardware “writes back” the descriptor to system memory 120 (with a 37 Descriptor Done” bit, and other possible status bits). The device driver 126 then takes the descriptor which is “done” and indicates the corresponding buffer to the protocol driver 128.

In certain embodiments, the hardware descriptors 158A, 158B . . . 158N are allocated in system memory 120, and the network adapter 150 would load the available descriptors 158A, 158B . . . 158N into the hardware. In such case, the system memory 120 may include a matching set of descriptors to descriptors that the network adapter 150 would load from the system memory 120 to the adapter 150 for internal processing and update (“writes back”) when the corresponding buffers are filled. In such embodiments, the software descriptors 134A, 134B . . . 134N are a separate set of descriptors which are not accessed by the network adapter 150, but which “mirror” the hardware descriptors.

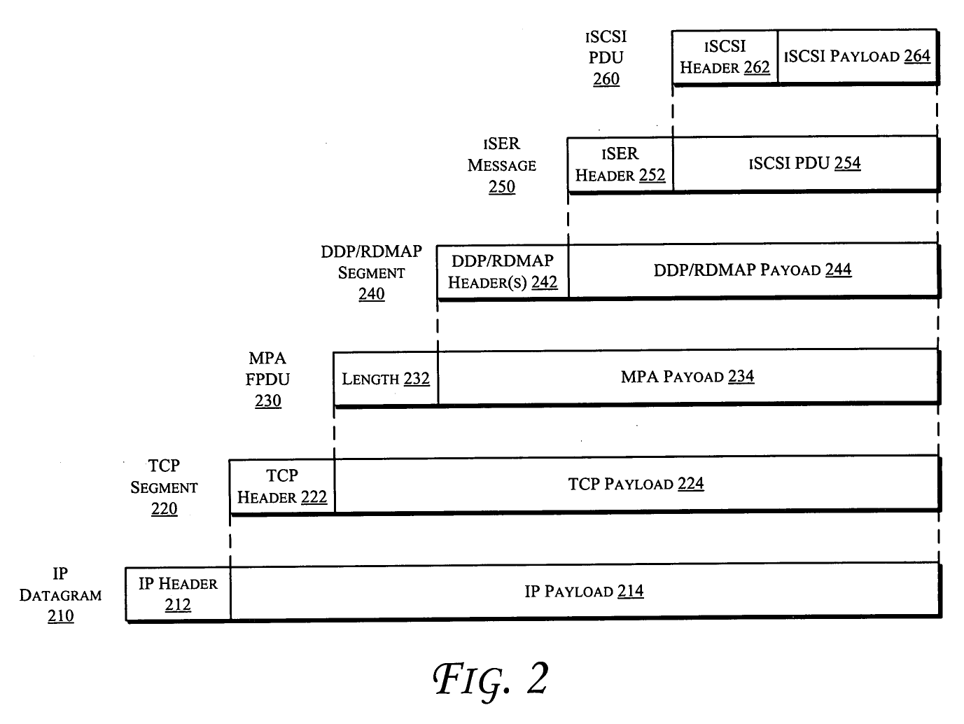

FIG. 2 is a schematic illustration of packet architectures used in examplary packet processing systems. The particular packet architecture illustrated in FIG. 2 is an iSCSI (Internet-Protocol Small Computer Serial Interface) architecture, and more particularly in the Datamover architecture, although the subject matter described herein is generally applicable to all packet architectures.

Referring to FIG. 2, the base packet architecture illustrated is an IP (Internet Protocol) datagram 210, which includes an IP header section 212 and a payload section 214. Embedded in the IP payload 214 is a TCP segment 220 which, in turn, includes a TCP header 222 and a TCP payload 224. Embedded in the TCP payload 224 is a Marker-based Protocol Data Unit alignment (MPA) frame relaying protocol data unit (FPDU) 230 which, in turn, includes a length header 232 and a MPA payload. The MPA Payload 234 includes a DDP/RDMAP (Datagram Delivery Protocol DDP/Remote Direct Memory Access Protocol) segment 240 which, in turn, includes a DDP/RDMAP header 242 and a DDP/RDMAP payload 244. The DDP/RDMAP payload 244 includes an iSER (iSCSI Extensions for RDMA) message 250 which, in turn, includes an iSER header 252 and an iSCSI PDU (Protocol Data Unit) 260. The iSCSI PDU 260 includes an iSCSI header 262 and an iSCSI payload 264.

The packet architecture depicted in FIG. 2 may be incorporated into a lower-layer protocol such as, e.g., an Ethernet protocol or any other suitable networking protocol.

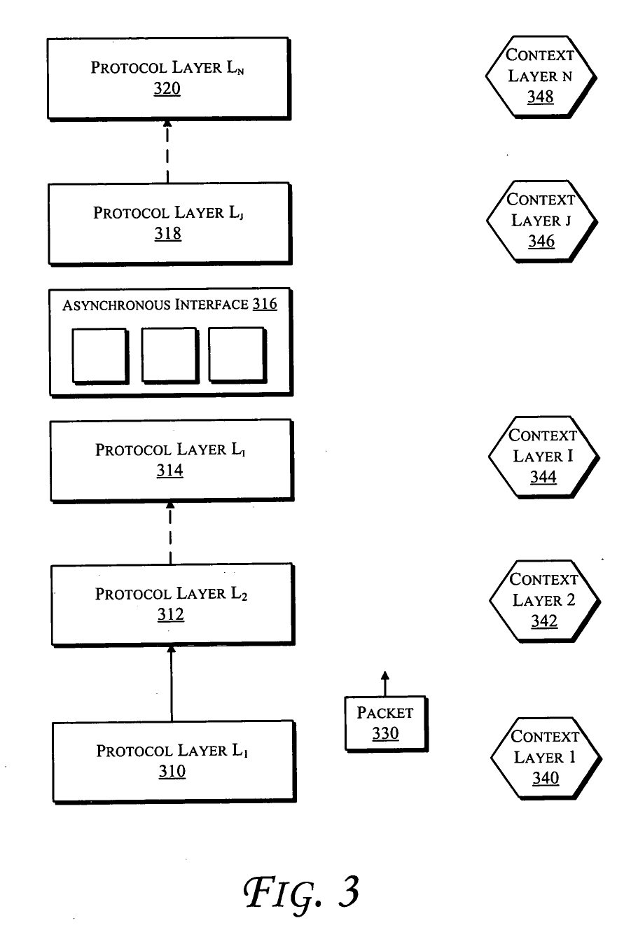

FIG. 3 is a schematic illustration of a generic layered packet processing environment. Referring to FIG. 3, a generic layered protocol stack comprises a plurality of protocol layers labeled protocol layer L₁ (310), protocol layer L₂ (312), protocol layer Lᵢ (314), protocol layer Lⱼ (318), and protocol layer Lₙ (320). The various protocol layers may be separated by synchronous interfaces such as, for example, upcalls executing as part of the same thread, or through asynchronous interfaces such as, for example a queue-based asynchronous interface 316, which may enable different threads to process the protocols on the two sides of the queue.

In operation, a data packet 330 received in the protocol stack is processed by the protocol layer L₁ first. In processing the data packet 330, protocol layer L₁ utilizes context information 340 for protocol layer L₁. Following completion of processing data packet 330 by protocol layer L1, the data packet 330 is passed up the stack to protocol layer L₂, which processes the packet using the context data for protocol layer L₂ 342. Each successive layer processes the data packet 330 using the context information associated with the layer and passes the data packet 330 up the stack until processing is complete.

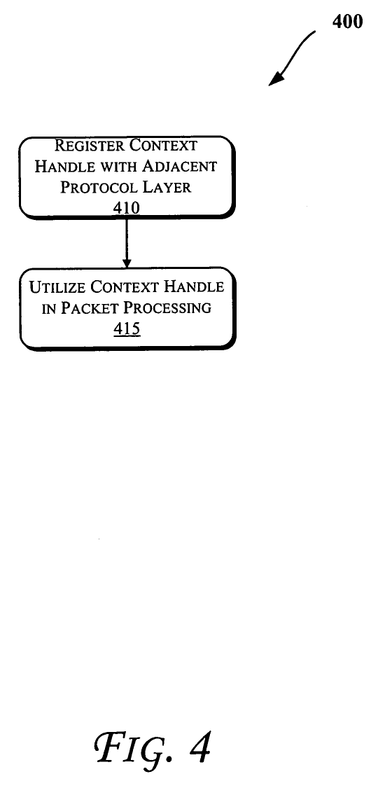

FIG. 4 is a flow diagram of an embodiment of a method to process packets in a generic layered packet processing environment. Referring to FIG. 4, at operation 410 a protocol process in a first protocol layer registers a context handle with an adjacent protocol layer. For example, in one embodiment an upper protocol layer may register a context handle with a lower protocol layer. In one embodiment of a processing environment each protocol layer in the stack executes operation 410 to register a context handle with a respective adjacent protocol layer. In alternate embodiments one or more protocol layers in the stack execute operation 410 to register a context handle with an adjacent layer protocol. In one embodiment, registering a context handle includes specifying a number of cache lines for the context data associated with the adjacent protocol layer. In one embodiment, registering a context handle includes registering a callback for the protocol layer. In alternate embodiments multiple context handles may be registered.

In one embodiment the context handles are meaningful only to the protocol layer and are treated as opaque by the adjacent layer. The context handles and the cache lines are associated with an adjacent protocol context using an inter-layer specific handle that is exchanged between the two layers. In one embodiment, the context handle is exchanged in a suitable data structure, and executed by a call to a context registration function, as follows:

```
struct opaque_context {
            void * context_handle;
            int num_cache_lines;
      }
llp_register_opaque_context (int inter_layer_handle, struct
opaque_context* p_ctx, int num_ctx);
```

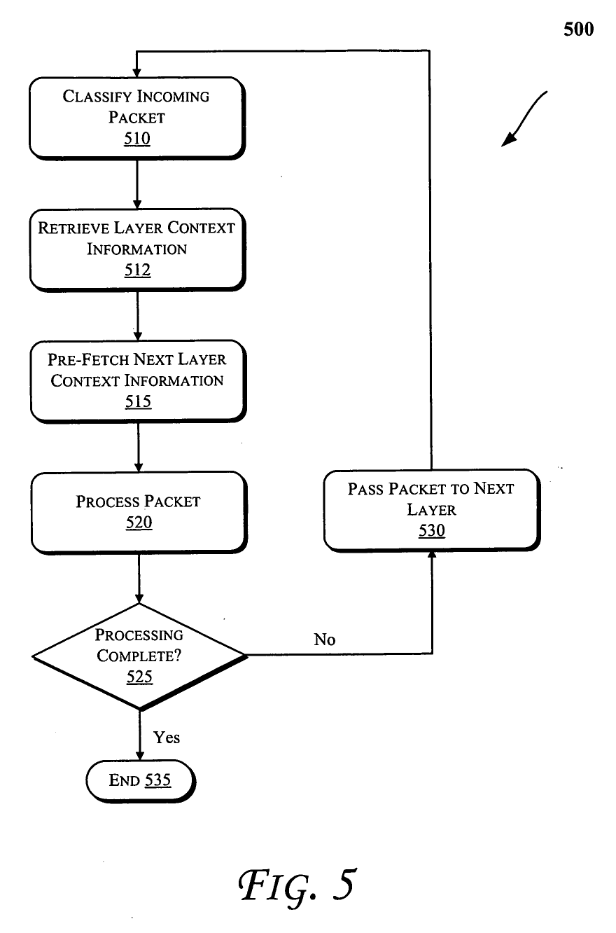

At operation 415, the context handle(s) registered in operation 410 are utilized in packet processing. In one embodiment, illustrated in FIG. 5, adjacent protocol layers use the context handles to pre-fetch context information for the protocol layer.

FIG. 5 is a flow diagram of an embodiment of a method to process packets in a generic layered packet processing environment. FIG. 5 generally describes operations that may be implemented by each layer in the protocol stack. In alternate embodiments fewer than all layers in the protocol stack implement the operations of FIG. 5.

Referring to FIG. 5, at operation 510 the current protocol layer classifies an incoming packet as belonging to a particular context. At operation 512 the protocol layer retrieves the context information for the current layer. At operation 515 the current protocol layer prefetches context information for the subsequent (i.e., upper or lower) layer in the protocol stack. In one embodiment, prefetching the context information includes passing the number of cache lines specified during the registration to a prefetching routine to permit the prefetching routine to move the context information to cache.

At operation 520 the protocol layer processes the packet. Packet processing may include, e.g., stripping a header from the packet, error checking, frame alignment, and the like. If, at operation 525 the packet has been processed (i.e., when the top layer protocol is complete) control passes to operation 535 and packet processing ends.

By contrast, if at operation 525 packet processing is incomplete, then control passes to operation 530 and the packet is passed to the next layer in the protocol stack. In one embodiment, passing the packet to the subsequent layer of the protocol may include invoking the callback associated with the subsequent protocol layer registered during the registration process. When the packet is passed to the subsequent protocol layer, the subsequent protocol may implement the operations 510-530 of FIG. 5. Hence, the operations of FIG. 5 may be repeated at each level of the protocol stack until the packet reaches the final layer of the stack.

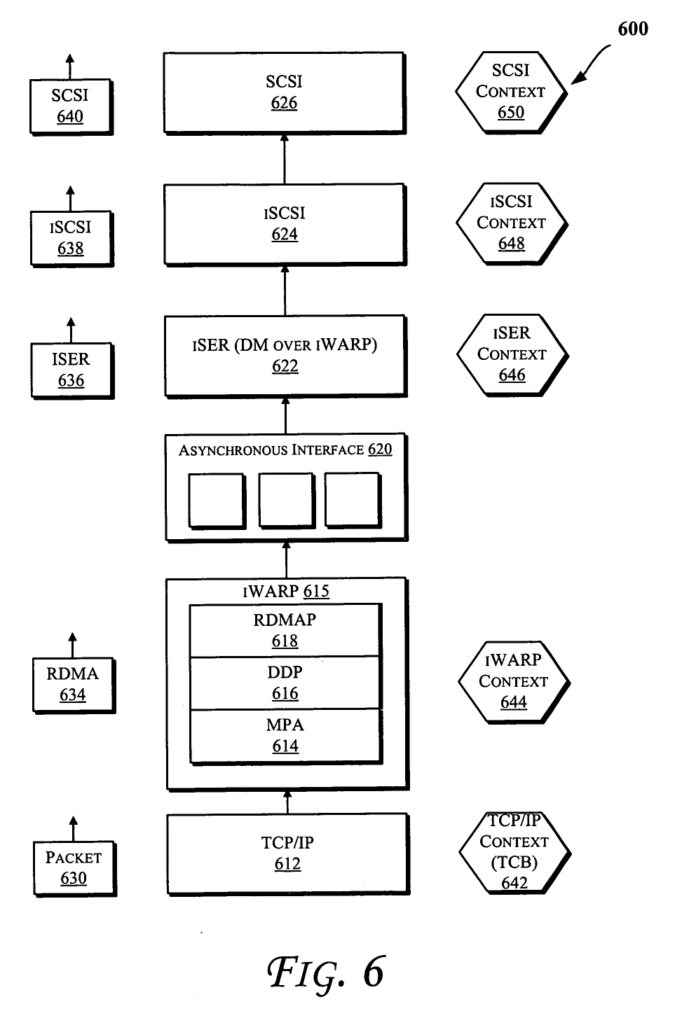

FIG. 6 is a schematic illustration of a specific layered packet processing environment 600 suitable for use in a computer-based information storage system. In one embodiment, the environment illustrated schematically in FIG. 6 is referred to as the Datamover architecture. The Datamover architecture permits iSCSI to utilize the data placement capabilities of one or more underlying transport layers (e.g., iWARP) via an intermediate layer (e.g., iSER). An example Datamover packet architecture is illustrated in FIG. 2.

Referring to FIG. 6, the processing environment 600 includes a TCP/IP layer 612 that utilizes TCP/IP context information 642 to process an incoming packet 630. In practice, TCP/IP layer 612 may be subdivided into a separate TCP layer and a separate IP layer. The processing environment 600 further includes an intermediate iWARP transport layer 615 that comprises an MPA layer 614, a DDP layer 616, and an RDMAP layer 618, which utilize iWARP context data 644 to process the an RDMA message 634 received from the TCP/IP layer 612.

In one embodiment the interfaces between the protocol layers may be implemented as synchronous interfaces such as, e.g., a callback function. In other embodiments the interface between one or more protocol layers may be implemented as a queue-based asynchronous interface such as asynchronous interface 620.

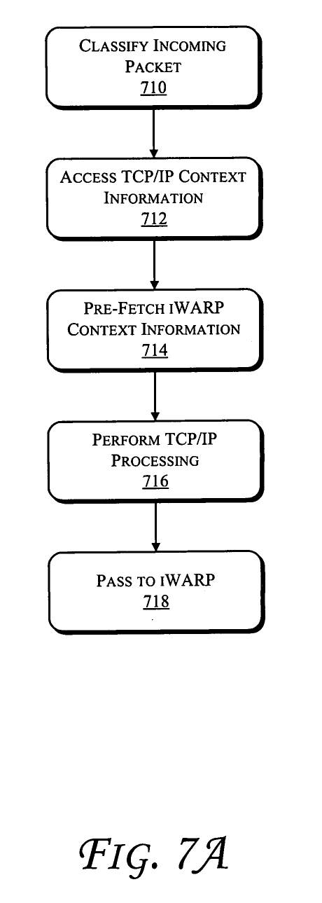

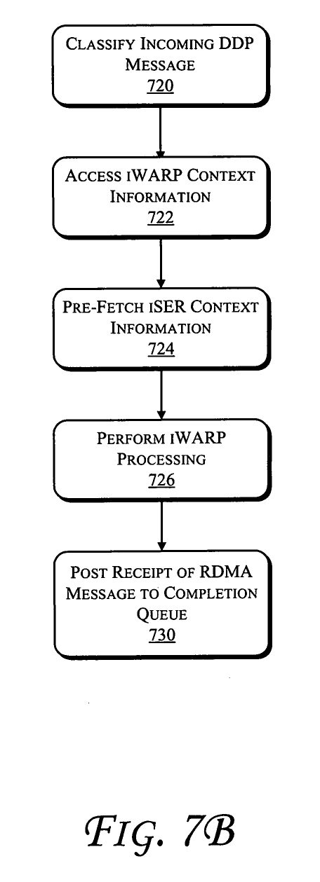

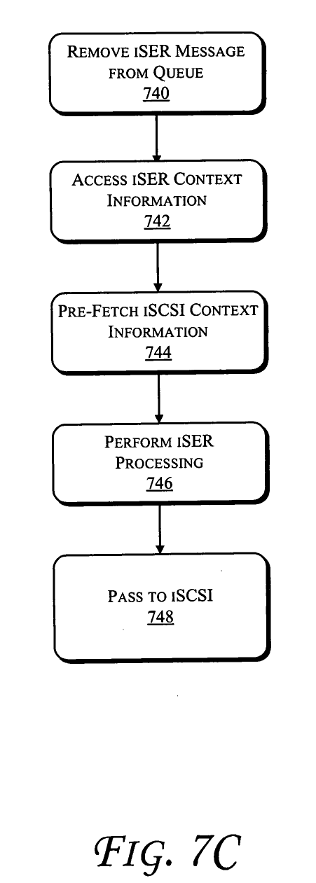

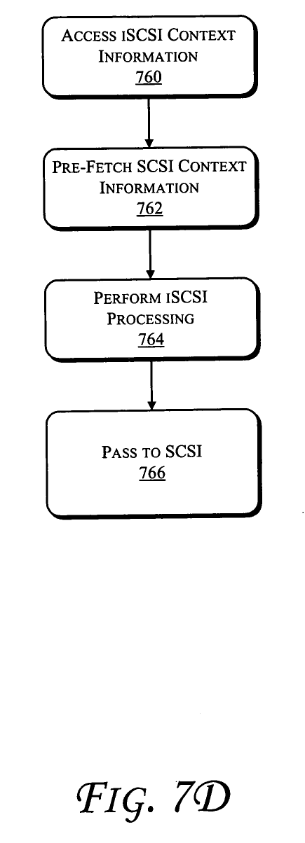

Processing environment 600 further includes an iSER layer 622 that utilizes iSER context information 646 to process the iSER control message 636 output by the RDMAP layer and generates an iSCSI PDU 638. In one embodiment, iSER layer 622 implements a direct memory access model using the transport service provided by the underlying composite iWARP layer. Processing environment 600 further includes an iSCSI layer 624 that processes the iSCSI PDU message 638 utilizing iSCSI context information 648 to generate the SCSI status PDU 640. Processing environment 600 further includes a SCSI layer 626 that processes the SCSI status PDU 640 utilizing SCSI context information 650. Operations implemented by the various layers of the processing environment 600 are explained in greater detail with reference to FIG. 7.

FIGS. 7A-7D are flow diagrams of an embodiment of a method to process packets in the specific layered packet processing environment depicted in FIG. 6. More particularly, FIGS. 7A-7D depict operations performed by the four lower protocol layers in processing a packet received in the processing environment. In one embodiment the processing environment executes a registration process as described with reference to FIG. 4, in which subsequent protocol layers register context handles and a callback with lower protocol layers.

FIG. 7A is a flow diagram of operations that may be performed by TCP/IP layer 612. Referring to FIG. 7A, at operation 710 an incoming packet is classified. In one embodiment, classifying the incoming packet includes locating the packet's transmission control block (TCB), which may be used to obtain information about the communication connection traversed by the packet. At operation 712 the TCP/IP context information is accessed. At operation 714 a prefetch operation is executed to prefetch iWARP context information. In one embodiment, the prefetch operation identifies the iWARP context and a number of lines in cache memory in which the iWARP context information should be stored.

At operation 716, TCP/IP processing is perfomed. In one embodiment, TCP/IP processing may include stripping header information from the TCP/IP packet. While TCP/IP processing is being performed, iWARP context information specified in the prefetch operation is retrieved and stored in the cache lines specified in the prefetch operation, e.g., as a background process. When TCP/IP processing is complete, the processed packet is passed to the iWARP layer 615, e.g., by executing a callback to the iWARP layer (operation 718).

FIG. 7B is a flow diagram of operations that may be performed by iWARP layer 615. Referring to FIG. 7B, at operation 720 an incoming DDP message is classified by the DDP layer 616. In one embodiment, classifying the incoming message includes determining whether the message is tagged for a specific memory buffer. At operation 722 the iWARP context information retrieved by the prefetch operation issued during TCP/IP processing is accessed from cache memory.

At operation 724 a prefetch operation is executed to prefetch iSER context information. In one embodiment, the prefetch operation identifies the iSER context and a number of lines cache memory in which the iSER context information should be stored.

At operation 726, iWARP processing is performed. In one embodiment, iWARP processing may include stripping header information from the MPA FPDU, and the DDP/RDMAP Segment (See FIG. 2). While iWARP processing is being performed, iSER context information specified in the prefetch operation is retrieved and stored in the cache lines specified in the prefetch operation, e.g., as a background process. When iWARP processing is complete, an iSER message is placed in a queue in the asynchronous interface 620.

FIG. 7C is a flow diagram of operations that may be performed by iSER layer 622. Referring to FIG. 7C, at operation 740 the iSER message is removed from the queue in the asynchronous interface 620. At operation 742 the iSER context information retrieved by the prefetch operation issued during iWARP processing is accessed from cache memory.

At operation 744 a prefetch operation is executed to prefetch iSCSI context information. In one embodiment, the prefetch operation identifies the iSCSI context and a number of lines in cache memory in which the iSCSI context information should be stored.

At operation 746, iSER processing is performed. In one embodiment, iSER processing may include stripping header information from the iSER message, (See FIG. 2). While iSER processing is being performed, iSCSI context information specified in the prefetch operation is retrieved and stored in the cache lines specified in the prefetch operation, e.g., as a background process. When iSER processing is complete, an iSCSI PDU is passed to the iSCSI layer 624, e.g., by executing a callback to the iSCSI layer (operation 748).

FIG. 7D is a flow diagram of operations that may be performed by iSCSI layer 624. Referring to FIG. 7D, at operation 760 the iSCSI context information retrieved by the prefetch operation issued during iSER processing is accessed from cache memory. In one embodiment, iSCSI context information may include both command information and connection information.

At operation 762 a prefetch operation is executed to prefetch SCSI context information. In one embodiment, the prefetch operation identifies the SCSI context and a number of lines in cache memory in which the SCSI context information should be stored.

At operation 764, iSCSI processing is performed. While iSCSI processing is being performed, SCSI context information specified in the prefetch operation is retrieved and stored in the cache lines specified in the prefetch operation, e.g., as a background process. When iSCSI processing is complete, an SCSI status is passed to the SCSI layer 626, e.g., by executing a callback to the SCSI layer (operation 766).

The operations described herein permit expedited processing of data packets by prefetching context information into cache before it is accessed. In various embodiments of the invention, the operations discussed herein, e.g., with reference to FIGS. 1-7, may be implemented as firmware, hardware (e.g., logic circuitry), and/or software that is provided as a computer program product, which may include a machine-readable or computer-readable medium having stored thereon instructions used to program a processor to perform a process discussed herein. The machine-readable medium may include any suitable volatile or non-volatile storage device. In one specific embodiment, the operations discussed with reference to FIGS. 1-7 may be embodied as logic instructions stored in the volatile memory of a network adapter. The network adapter controller, when configured by the logic instructions, constitutes structure for implementing the operations.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment of the invention is included in at least an implementation. The appearances of the phrase “in one embodiment” in various places in the specification may or may not be all referring to the same embodiment of the invention.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method comprising:
receiving a data packet into a multi-layer communication protocol processor; and
in a current protocol layer:
prefetching context data associated with a subsequent protocol layer;
processing the data packet in accordance with the current protocol layer; and
passing a portion of the processed data packet to the subsequent protocol layer.

2. The method of claim 1, wherein prefetching context data associated with a subsequent protocol layer comprises executing, in the protocol layer, a prefetch operation that identifies a subsequent layer context and a number of cache lines.

3. The method of claim 1, wherein processing the data packet in accordance with the current protocol layer comprises modifying information in the data packet.

4. The method of claim 1, wherein passing a portion of the processed packet to the subsequent protocol layer comprises passing the portion of the processed packet across a synchronous interface or an asynchronous interface.

5. The method of claim 2, further comprising processing the data packet in the subsequent protocol layer using data stored in the cache lines by the prefetch operation.

6. A method to operate a multi-layer network packet processor, comprising:
executing a registration routine in which in a first protocol layer registers an opaque context handle with an adjacent protocol layer;
executing a packet processing routine in which the adjacent protocol layer
receives a data packet; and
prefetches context data associated with the first protocol layer before processing the data packet in accordance with the adjacent protocol layer.

7. The method of claim 6, wherein executing a registration routine further comprises identifying a number of cache lines.

8. The method of claim 6, wherein executing a registration routine further comprises registering an interface for the first protocol layer.

9. The method of claim 6, further comprising passing a portion of the data packet to the first protocol layer.

10. The method of claim 9, wherein passing a portion of the data packet to the first protocol layer comprises passing the portion of the processed packet across a synchronous interface or an asynchronous interface.

11. A computer program product comprising logic instructions stored on a computer-readable medium which, when executed by a processor, configure the processor to operate a multi-layer network packet processor by performing operations, comprising:
executing a registration routine in which in a first protocol layer registers an opaque context handle with an adjacent protocol layer;
executing a packet processing routine in which the adjacent protocol layer
receives a data packet; and
prefetches context data associated with the first protocol layer before processing the data packet in accordance with the adjacent protocol layer.

12. The computer program product of claim 11, further comprising logic instructions which, when implemented by the processor, configure the processor to identify a number of cache lines for the context data associated with the first protocol layer.

13. The computer program product of claim 11, further comprising logic instructions which, when implemented by the processor, configure the processor to register an interface for the first protocol layer.

14. The computer program product of claim 11, further comprising logic instructions which, when implemented by the processor, configure the processor to pass a portion of the data packet to the first protocol layer.

15. The computer program product of claim 11, further comprising logic instructions which, when implemented by the processor, configure the processor to pass the portion of the processed packet across a synchronous interface or an asynchronous interface.

16. A system, comprising:
a processor;
a storage device;
a network adapter including a controller and logic to configure the controller to operate a multi-layer network packet processor to:
execute a registration routine in which in a first protocol layer registers an opaque context handle with an adjacent protocol layer;
execute a packet processing routine in which the adjacent protocol layer receives a data packet and prefetches context data associated with the first protocol layer before processing the data packet in accordance with the adjacent protocol layer.

17. The system of claim 16, wherein the multi-layer network packet processor identifies a number of cache lines for the context data associated with the first protocol layer.

18. The system of claim 16, wherein the multi-layer network packet processor registers an interface for the first protocol layer.

19. The system of claim 16, wherein the multi-layer network packet processor passes a portion of the data packet to the first protocol layer.

20. The system of claim 16, further wherein the multi-layer network packet processor passes the portion of the processed packet across a synchronous interface or an asynchronous interface.
